(19) United States
(12) Patent Application Publication
(10) Pub. No.: US 2007/0138220 A1
(43) Pub. Date: Jun. 21, 2007

(54) Universal bag well

(75) Inventors: Derek W. Haines, Bangkok (TH); Bradley J. Hanson, North Augusta, SC (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/311,912

(22) Filed: Dec. 19, 2005

(51) Int. Cl. B60R 9/00

(52) U.S. Cl. 224/274

(57) ABSTRACT

A golf bag well arrangement on a golf car includes a receiving area adapted to receive at least one golf bag in a secure position. A first support surface is arranged on the receiving area and defines a first plane. A second support surface is defined on the receiving area and defines a second plane. A first retaining wall extends between an outer boundary of the first support surface and an inner boundary of the second support surface. The first plane is parallel and offset to the second plane.

### TECHNICAL FIELD

The present invention relates to golf cars and more specifically to a golf bag well for accommodating a variety of golf bags.

### BACKGROUND

Golf cars provide transportation for golfers around a golf course. A golf car must also securely carry a golf bag in a location for convenient access throughout a round of golf. Typically, the rearward portion of the golf car defines a golf bag carrier area that supports the golf bag or bags in a centrally upright orientation. In one application, a support brace is provided for aligning with an upper portion of the golf bag and providing lateral support. Generally, a strap is affixed to the support brace for securing the golf bag to the golf car. A free end of the strap may be looped around the upper portion of the golf bag and pinched into a retained position with a swing arm pivotally mounted to the support brace. Often, two strap arrangements are available at the golf bag carrier area for accommodating two golf bags

The golf bag carrier area typically defines a bag well for accepting a base portion of the golf bags. Usually the bag well defines outer walls such that a golf bag, or bags, may nest in the bag well in a secure position. With the variety of golf bag configurations available today however, sometimes the dimensions of the bag well are not suitable for retaining the base of some golf bags securely. As a result, sometimes the golf bag may slide along its base portion in the bag well throughout a round of golf.

### SUMMARY

A golf bag well arrangement on a golf car includes a receiving area adapted to receive at least one golf bag in a secure position. A first support surface is arranged on the receiving area and defines a first plane. A second support surface is defined on the receiving area and defines a second plane. A first retaining wall extends between an outer boundary of the first support surface and an inner boundary of the second support surface. The first plane is parallel and offset to the second plane.

According to other features, the first retaining wall is transverse to the first and second plane. A third support surface is defined on the receiving area and defines a third plane. A second retaining wall extends between an outer boundary of the second support surface and an inner boundary of the third support surface.

The receiving area is operable to support one of a first bag on the first planar support surface and a second bag on the second planar support surface. The first retaining wall is adapted to bound an outer dimension of the first golf bag in an installed position. The second retaining wall is adapted to bound an outer dimension of the second golf bad in an installed position.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a golf car incorporating a universal bag well according to the present teachings;

FIG. 2 is a perspective view of the golf car of FIG. 1 shown with a first golf bag approaching the universal bag well;

FIG. 3 is a perspective view of the golf car of FIG. 1 shown with a second golf bag approaching the universal bag well;

FIG. 4 is a plan view of the universal bag well of FIG. 1;

FIG. 5 is a sectional view of the universal bag well shown with the first golf bag of FIG. 2 in an installed position; and

FIG. 6 is a sectional view of the universal bag well shown with the second golf bag of FIG. 3 in an installed position.

### DETAILED DESCRIPTION

The following description of the various embodiment(s) is merely exemplary in nature and is in no way intended to limit the invention, its application, or uses.

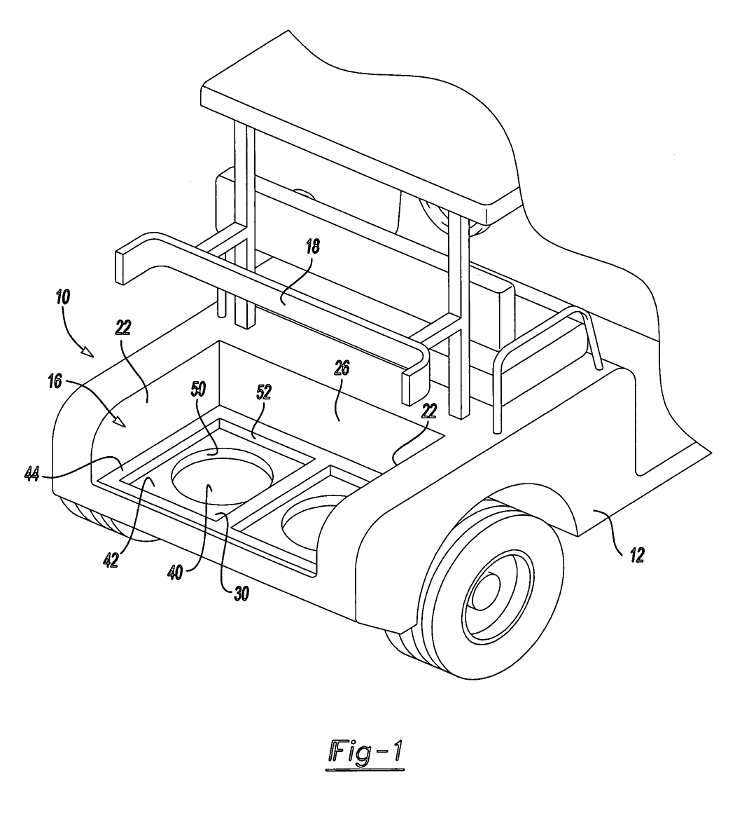

With initial reference to FIG. 1, a universal bag well according to the present teachings is shown and generally identified at reference 10. The bag well 10 is shown arranged on a golf car 12. The universal bag well 10 defines a lower boundary of a golf bag carrier area 16. An upper front boundary of the golf bag carrier area 16 is defined by a support brace 18. The support brace 18 is generally positioned on the golf car 12 to provide lateral support to the golf bag or bags while the golf bags are positioned in an upright manner on the universal bag well 10. The universal bag well 10 is generally defined between golf car wheel wells 22 and rearward of a well wall 26. The lower boundary of the universal bag well 10 includes a receiving area 30. As will be described in greater detail, the receiving area 30 of the universal bag well 10 is configured to accept golf bags having distinct geometries in a secure position.

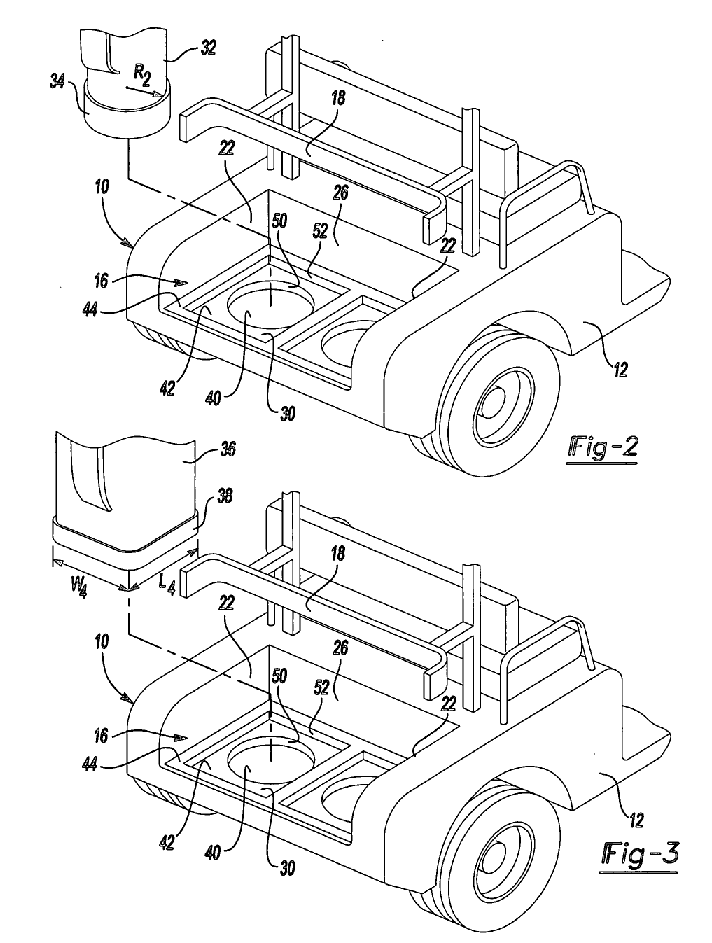

With continued reference to FIG. 1 and further reference to FIGS. 2 and 3, the universal bag well 10 will be described in greater detail. The receiving area 30 of the universal bag well 10 is adapted to accept a pair of golf bags concurrently in a side by side configuration. As illustrated in FIG. 2, a first exemplary golf bag 32, includes a generally cylindrical base portion 34. Alternatively, as illustrated in FIG. 3, a second exemplary golf bag 36 includes a generally rectangular base portion 38. For purposes of discussion, the receiving area 30 arranged on a drivers' side of the golf car 12 will be described in greater detail. It is appreciated however, that a receiving area 30 with the same configuration is provided on the passenger's side of the universal bag well 10.

The receiving area 30 includes a first, second, and third support surface 40, 42, and 44 respectively. A first retaining wall 50 extends between an outer boundary of the first support surface 40 and an inner boundary of the second support surface 42. The first retaining wall 50 is generally cylindrical in shape and has a depth D₁ (FIG. 5). The first retaining wall 50 is configured to accept a golf bag having a cylindrical base portion (such as golf bag 32 having cylindrical base portion 34). A second retaining wall 52 extends between an outer boundary of the second support surface 42 and an inner boundary of the third support surface 44. The second retaining wall 52 is generally rectangular in shape and has a depth D₂ (FIG. 5). The second retaining wall 52 is configured to accept a second golf bag having a rectangular base portion (such as golf bag 36 having rectangular base portion 38).

The first, second, and third support surfaces are parallel and offset from each other (FIG. 5). As a result, the first second and third support surfaces 40, 42, and 44 present a stepped configuration whereby a planar support surface 40, 42 and 44 and a complementary retaining wall 50 and 52 (or wheel well 22 and well wall 26) can be utilized to accept golf bags having various geometries. It is appreciated that while the first support surface 40 is shown bounded by a first retaining wall 50 having a cylindrical geometry and the second support surface 42 is shown bounded by a second retaining wall 52 having a rectangular geometry, the geometries may be reversed. Alternatively, the first and second retaining walls 50 and 52 may each present a cylindrical wall or each present a rectangular wall.

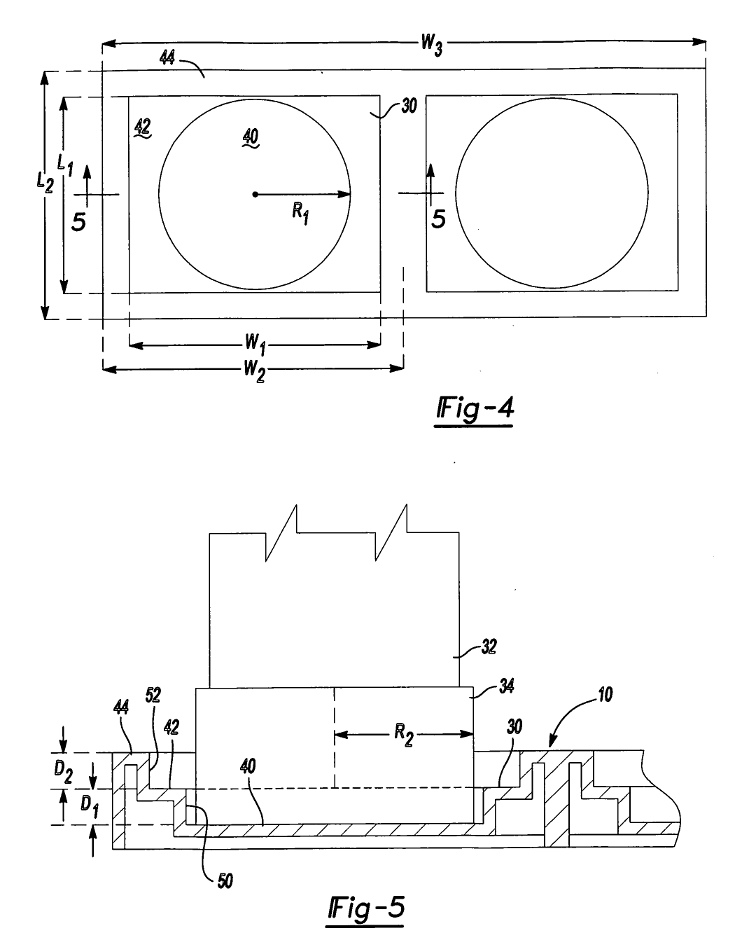

Turning now to FIG. 4, exemplary dimensions of the universal bag well 10 will be discussed. It is appreciated however that the dimensions described herein are merely exemplary and other dimensions may be defined on the receiving area 30 without departing from the present teachings. In general, the first support surface 40 may be adapted to accommodate a smaller footprint golf bag such as those around 229 mm in diameter. The second support surface 42 may be adapted to accommodate a larger footprint golf bag such as those around 267 mm in diameter. The first support surface 40 may include a radius R₁ of about 114 mm. The second support surface 42 may include a length L₁ of about 277 mm and a width W₁ of about 292 mm. The third support surface 44 includes a length L₂ of about 279 mm and a width W₂ of about 305 mm. The bag well 10 as a whole includes a width W₃ of about 610 mm.

With reference now to FIG. 5, the stepped configuration of the bag well 10 allows a base of a golf bag such as the golf bag 32 having the cylindrical base portion 34 to nest within the first retaining wall 50 and be supported by the first support surface 40. The exemplary golf bag 32 has a base defining a radius R₂. The radius R₂ is less than the radius R₁. A golf bag having a base defining a radius less than R₂ may also be accommodated by the first support surface 40.

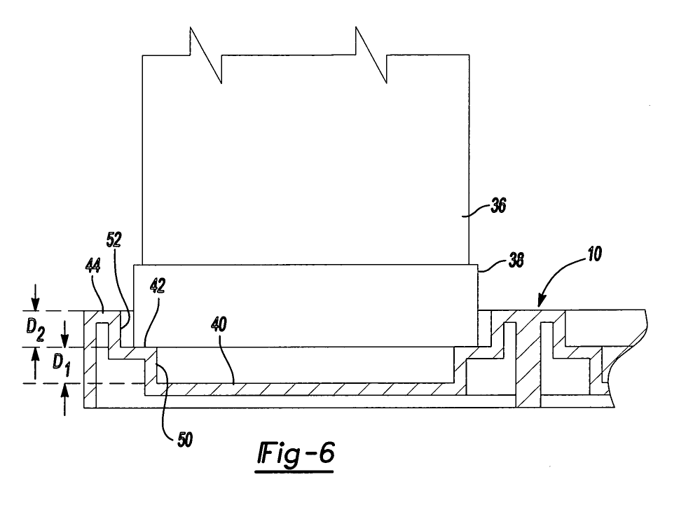

With reference now to FIG. 6, the golf bag 36 having the rectangular base portion 38 is shown accepted onto the second support surface 42. In an installed position (FIG. 6) the rectangular base 38 nests within the second retaining wall 52 and is supported by the second support surface 42. The exemplary golf bag 36 has a base having a length L₄ and a width W₄ (FIG. 3) A golf bag having a base defining a length and width less than L₁ and W₁, respectively, may also be accommodated by the second support surface 42.

While not specifically shown, a golf bag having a base portion defining a length and/or width greater than L₁ and W₁ and less than L₂ and W₂ may be supported by the third support surface 44. While such a golf bag will not specifically nest within a recess, it may be supported on a forward side by the well wall 26 and on a lateral side by one of the wheel wells 22.

The receiving area 30 of the bag well 10 may be made of a rigid material such as, but not limited to plastic. The receiving area 30 may be made as a standalone component and subsequently secured to the golf car 12 in the golf bag carrier area 16 such as by way of conventional fasteners or a flowable bonding compound. Alternatively, the receiving area 30 may comprise an integral component of the golf car 12. In one example, the receiving area 30 may be integrally formed with the golf car wheel wells 22 and/or the well wall 26.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

What is claimed is:

1. A golf bag well arrangement on a golf car comprising:
a receiving area defined on the golf car and adapted to accept at least one golf bag in a secure position;
a first support surface arranged on said receiving area and defining a first plane;
a second support surface defined on said receiving area and defining a second plane; and
a first retaining wall extending between an outer boundary of said first support surface and an inner boundary of said second support surface;
wherein said first plane is parallel and offset to said second plane.

2. The golf bag well arrangement of claim 1 wherein said first retaining wall is transverse to said first and second plane.

3. The golf bag well arrangement of claim 2, further comprising a third support surface defined on said receiving area and defining a third plane.

4. The golf bag well arrangement of claim 3, further comprising a third retaining wall.

5. The golf bag well arrangement of claim 4, further comprising a second retaining wall extending between an outer boundary of said second support surface and an inner boundary of said third support surface.

6. The golf bag well arrangement of claim 2 wherein said first retaining wall defines a cylindrical cross-section.

7. The golf bag well arrangement of claim 5 wherein said receiving area is operable to support one of a first bag on said first planar support surface and a second bag on said second planar support surface, wherein said first retaining wall is adapted to bound an outer dimension of said first golf bag in an installed position and wherein said second retaining wall is adapted to bound an outer dimension of said second golf bag in an installed position.

8. The golf bag well of claim 7 wherein said first support surface includes a pair of adjacent first support surfaces and wherein said second support surface includes a pair of adjacent second support surfaces.

9. A golf bag well arrangement on a golf car comprising:
a receiving area defined on the golf car and adapted to accept one of a first golf bag having a first base portion and a second golf bag having a second base portion in a secure position;
a first support surface arranged on said receiving area and defining a first plane;
a second support surface defined on said receiving area, said second support surface stepped outwardly relative said first support surface and defining a second plane; and
a first retaining wall extending between an outer boundary of said first support surface and an inner boundary of said second support surface.

10. The golf bag well arrangement of claim 9 wherein said first retaining wall is transverse to said first and second plane.

11. The golf bag well arrangement of claim 10, further comprising a third support surface defined on said receiving area and defining a third plane.

12. The golf bag well arrangement of claim 11, further comprising a third retaining wall.

13. The golf bag well arrangement of claim 12, further comprising a second retaining wall extending between an outer boundary of said second support surface and an inner boundary of said third support surface.

14. The golf bag well arrangement of claim 10 wherein said first retaining wall defines a cylindrical cross-section.

15. The golf bag well arrangement of claim 13 wherein said second retaining wall defines a rectangular cross-section.

16. The golf bag well arrangement of claim 9 wherein said first base portion defines a cylindrical cross-section and wherein said second base portion defines a rectangular cross-section.

17. A golf bag well arrangement on a golf car comprising:
a receiving area defined on the golf car and adapted to accept one of a first golf bag having a first base portion and a second golf bag having a second base portion in a secure position;
a first support surface arranged on said receiving area and defining a first plane;
a second support surface defined on said receiving area, said second support surface stepped outwardly relative said first support surface and defining a second plane;
a first retaining wall defining a first cross-section and extending between an outer boundary of said first support surface and an inner boundary of said second support surface, said first retaining wall adapted to bound said first base portion of said first golf bag in said secure position; and
a second retaining wall defining a second cross-section and extending from an outer boundary of said second support surface, said second retaining wall adapted to bound said second base portion of said second golf bag in said secure position.

18. The golf bag well arrangement of claim 17 wherein said first retaining wall is transverse to said first and second plane.

19. The golf bag well arrangement of claim 18, further comprising a third support surface defined on said receiving area, said third support surface defining a third plane.

20. The golf bag well arrangement of claim 19, further comprising a third retaining wall.

21. The golf bag well arrangement of claim 17 wherein said first base portion defines a cylindrical cross-section and wherein said second base portion defines a rectangular cross-section.

22. The golf bag well arrangement of claim 21 wherein said first cross-section is cylindrical and said second cross-section is rectangular.
